(19) United States
(12) Patent Application Publication
(10) Pub. No.: US 2011/0153426 A1
(43) Pub. Date: Jun. 23, 2011

(54) MOBILE DEVICE ADVERTISING

(75) Inventors: RAYMOND REDDY, TORONTO (CA); SANG-HEUN KIM, TORONTO (CA)

(73) Assignee: PUSHLIFE INC., Toronto (CA)

(21) Appl. No.: 12/971,766

(22) Filed: Dec. 17, 2010

Related U.S. Application Data
(60) Provisional application No. 61/287,430, filed on Dec. 17, 2009.

(51) Int. Cl. G06Q 30/00

(52) U.S. Cl. 705/14.58; 705/14.64

(57) ABSTRACT

Implementations for mobile device advertising are disclosed. In at least one implementation, a method for a mobile device is disclosed that includes: obtaining a plurality of advertisement content items at a mobile device via a communication network; storing the plurality of advertisement content items at a storage device of the mobile device; selecting an advertisement content item from the plurality of advertisement content items stored at the storage device based, at least in part, on an advertisement selection parameter; and presenting the advertisement content item selected from the plurality of advertisement content items stored at the storage device via an output device of the mobile device. In at least some implementations, the advertisement selection parameter includes attributes of media content stored at the storage device of the mobile device or accessed by a user via the mobile device.

### PRIORITY CLAIM

The present application claims priority to provisional patent application U.S. 61/287,430, titled ASYNCHRONOUS ADVERTISING SYSTEM FOR MOBILE DEVICES, filed Dec. 17, 2009, the entire contents of which are incorporated herein by reference in their entirety for all purposes.

### BACKGROUND

Mobile devices such as mobile phones, personal digital assistants, laptop or notebook computers, and other mobile computing platforms may communicate via a wireless network. Advertisers may advertise to mobile device users by presenting advertisement content under select conditions. However, the presentation of advertisement content at a mobile device may be impaired during periods of degraded wireless communication with the mobile device.

### SUMMARY

Implementations for mobile device advertising are disclosed. In at least one implementation, a method for a mobile device is disclosed that includes obtaining a plurality of advertisement content items at a mobile device via a communication network and storing the plurality of advertisement content items at a storage device of the mobile device. The method further includes selecting an advertisement content item from the plurality of advertisement content items stored at the storage device based, at least in part, on an advertisement selection parameter. The method further includes presenting the advertisement content item selected from the plurality of advertisement content items stored at the storage device via an output device of the mobile device. In at least some implementations, the advertisement selection parameter includes attributes of media content stored at the storage device of the mobile device or accessed by a user via the mobile device.

### BRIEF DESCRIPTION OF DRAWINGS

FIGS. 1-8 depict example implementations of mobile device advertising as described in greater by the detailed description.

FIG. 9 is a schematic diagram depicting an example network environment according to one implementation.

FIG. 10 is a flow diagram depicting an example method for a mobile device according to one implementation.

FIG. 11 is a flow diagram depicting an example method for a computing device according to one implementation.

### DETAILED DESCRIPTION

An advertising system and method of operation for mobile devices is disclosed, including a distributed advertising system and method of operation where the decisions for selecting or presenting advertising content may on one or more of an advertisement server, personal computer, or a mobile device.

Recent advances in technology have resulted in users of mobile phones and other mobile devices to perform functions such as web browsing, media playback, media browsing, media purchasing, and operate productivity software much like they would on their personal computers.

As users increase their time spent on mobile devices, online advertising platforms seek to effectively advertise to users on mobile devices as well. There are a number of challenges that currently degrade the advertising experience for users on mobile devices. For example, mobile applications need to deal with the complexity of managing a data connection to serve, present, and track advertising content on a mobile device. Certain devices may not have data storage or processing capability, and some devices may have sporadic data coverage affecting the reach and availability of the advertising service provided by remote computing devices. As a result, advertising may be ineffective because a user may be unable to ‘click through’ on an advertisement to obtain additional information if the data connection is interrupted, or a user may not be able to take action and complete a purchase on a mobile device if their browser is not capable of doing so. Further, since most advertising platforms are web-based, the richness of the advertising medium is limited by the capability of the mobile phone's web browser (the browser and website may not support audio/video, animations, etc. even though the phone may be capable of doing so). Downloading rich advertising can be slow over a data connection, especially if the advertising contains media elements such as pictures, audio and video. This usually results in high abandonment rates as user may cancel the action or skip the advertisement because of the delay in downloading media. For this reason mobile applications, and especially advertising, benefit from instant or improved responsiveness to keep users' attention. With traditional advertising platforms, delivering highly targeted advertising requires may involve sending sensitive private user information to centralized servers for processing which users may object to or may cause liability based on privacy laws in certain jurisdictions.

Overview

The implementation disclosed herein provide a system, method, and computer program for delivering and tracking mobile advertising asynchronously on mobile devices with intermittent or no data connectivity. Mobile devices may have reduced processing capability, data connectivity, and storage capacity as compared to personal computers. However recent trends in micro storage and expandable memory such as microSD cards are resulting in significant improvements in storage capacity of mobile devices. For example many mobile devices can support 16 GB and even up to 32 GB or more of expandable memory. Systems that can exploit this increase storage capacity to reduce application dependence on data networks can reduce latency and wait time for users, making applications more responsive and immediate. This is especially useful for advertising platforms where sluggish applications and long wait times result in high abandonment rates for advertising reducing the effectiveness and revenue generated by advertising screen real estate on a mobile device.

The disclosed implementations provide a network-implementable computer architecture to intelligently store advertising on the local memory of a mobile device and enables applications on the mobile device to access, use and display locally stored advertising so that applications are not dependent on the mobile phone's data connection or web browser capabilities for advertising.

The disclosed implementations further enable applications on a mobile device to store, use and display advertising even if the primary advertisement server is not available using a data connection available to the mobile device, or when there is no data connection or degraded data connection available to the mobile device.

The disclosed implementations significantly improve the mobile advertising experience to users of mobile devices by reducing network wait time for advertising and enables applications running on mobile devices to use rich advertising making optimal use of the handsets media capabilities.

Current Systems

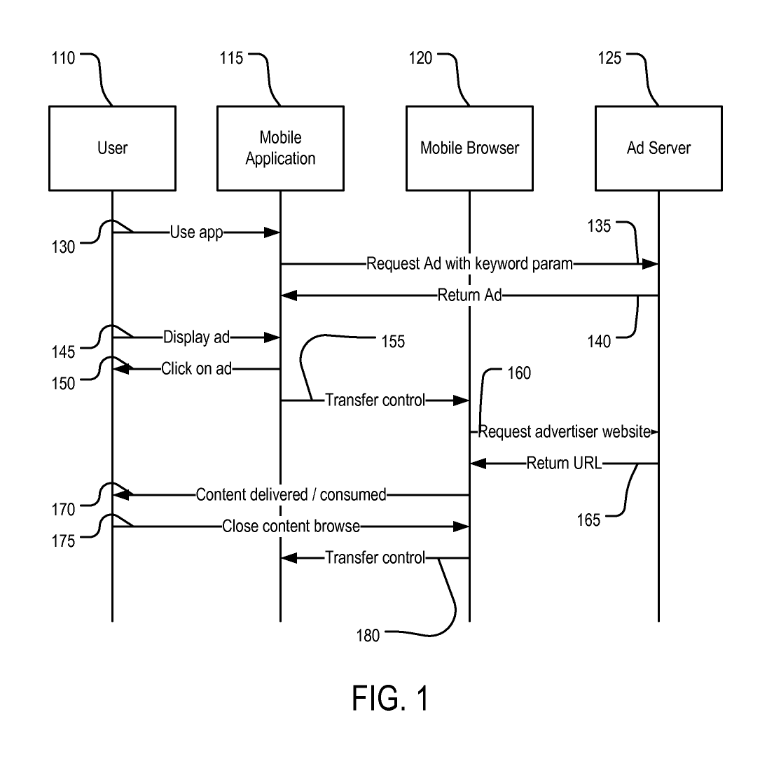

FIG. 1 illustrates an example interaction between a mobile browser 120 running on a mobile device and an advertisement server 125. Current advertising platforms on mobile devices operate similar to the Internet advertising model on desktop computers. A user can start interacting with an application 130 on their mobile phone. On one or more screens the mobile application may request advertising 135 from the Advertisement server (using keywords or other means of context) to be displayed to the user. From time to time a user may click 150 or otherwise invoke the advertisement which results in the mobile application requesting and displaying further advertising details usually by transferring control to a web browser on the mobile device that may connect the user to the advertiser's website or other landing page or micro site created for the advertisement.

There are two areas of dependence on data connections here. Firstly, interactions with the advertisement server require the presence of a wireless data connection to request and display advertising. Secondly, the data connection is required to complete a ‘click-through’ and allow the user to click on an advertisement within the application resulting in the application invoking the web browser to transfer the user to the advertiser's website. The service cannot function correctly if the data connection is interrupted during any of the above actions. Additionally, the advertisers are limited to the capability of the web browser which may not fully support the media capabilities of the phone such as support for audio and video playback. In all cases the service is unavailable on mobile devices that do not have or are not capable of facilitating data connections.

System Architecture

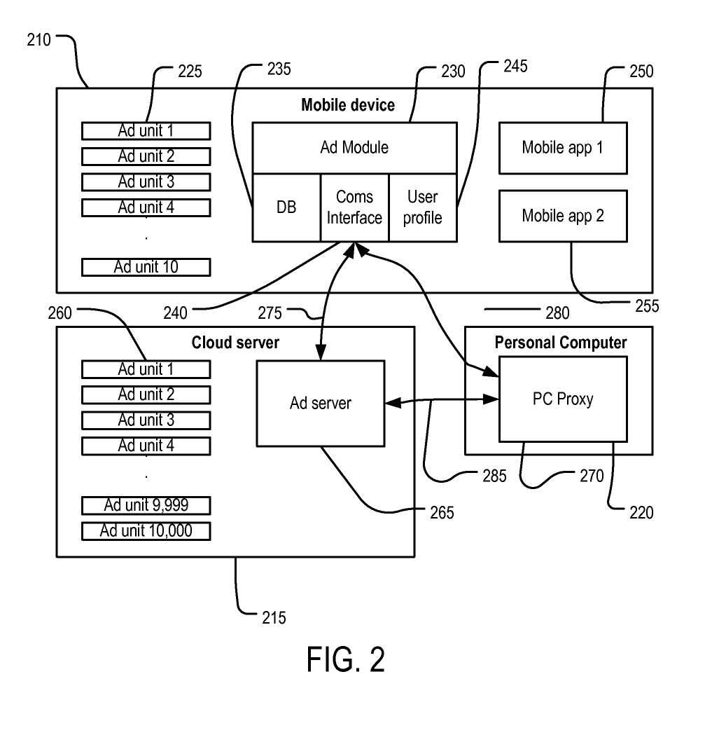

FIG. 2 illustrates the system architecture of the present invention. Advertisement server 265 is the central repository that manages advertising inventory and performs statistics and tracking of advertising data centrally, which may be similar in at least some aspects to a traditional advertisement server. Advertisement server 265 may interface with a number of other systems to provide real time tracking and reports to advertisers. In the present disclosure, advertisement server 265 creates an advertising collection 225 from its inventory to be stored locally on mobile device 210 and manages and refreshes the advertising collection 225 from time to time over a wired or wireless data connection. The advertisement server may randomly choose advertising from its inventory 260 to create a collection or may uses information and data about the mobile device 210 and the user as well as information about the content or applications 250 and 255 present on or accessed via the mobile device to optimally create a collection of advertising 225 to store on the mobile device or to refresh a previously stored collection over a wired or wireless data connection. From time to time, mobile device 210 may send tracking and reporting data to advertisement server 265 or may be polled by advertisement server 265 for such data over a wired or wireless connection. This data may be used along with other available analytic data to refine the collection of advertising 225 on the mobile device and better determine and select advertisements for the mobile device during future updates. In at least some implementations, advertisement server 265 may be responsible for creating and managing collections of advertising stored on a mobile device and receiving tracking data for such advertising relating to usage and consumption.

Advertisement Module

Advertisement module 230 is an interface between mobile applications and advertisement units on the mobile device 210. Mobile applications 250 and 255 on the device may use the Advertisement module 230 as a gateway to interact with and use locally stored advertising 225 in a similar manner to a remote advertisement server. On-device advertisement module may be a separate application invoked by other applications or a process embedded in the device operating system accessible by applications running on the device.

In one implementation, the advertisement module may use a database to maintain an index of advertising units and track statistics such as number of impressions served, click through rates etc. The database may contain a variety of information on Ad units including detailed descriptions and transcripts of audio/video advertising to perform contextual analysis using keywords. The advertisement module may also operate a communication interface to interact with the advertisement server. The interface may facilitate bi-directional communication over a wired or wireless network connection so that the advertisement module may send statistics and other tracking information to the advertisement server and receive new collections of advertising.

An application on the mobile device may request an advertisement from the advertisement module by calling its API and passing relevant parameters (caller application, size parameters of the advertising, category, type, among other parameters described herein, etc.). The advertisement module may return an advertisement and a unique identifier or domain unique identifier to invoke advertising details if the user clicks or otherwise selects the advertisement.

Proxy Computer

An personal computer proxy 270 may be used in at least some implementations to serve a number of useful functions described herein. For data devices that are not capable of wireless data transfer, the PC proxy may retrieve tracking data and statistics from the mobile device over a USB or Bluetooth connection when one is made between the device and the PC. The PC proxy may then transfer such data to the advertisement server over an internet connection. Similarly the PC proxy may download new advertising units from the advertisement server and sideload the collection of advertising on to the mobile device. This may be preferable over other implementations even if the mobile device is capable of downloading such content wirelessly for speed and bandwidth optimization. In this way, the PC Proxy may act as a data connection proxy to synchronize data between the mobile device and the advertisement server.

The PC Proxy may also enable users to complete actions or transactions that started or were initiated on the mobile device. For example the user may indicate interest in purchasing content based on advertising displayed on the mobile device but actually complete the transaction on the personal computer. A user may also indicate interest in an advertisement by clicking on the advertisement but unable to view further advertising data because it is in a format that is not supported by the mobile device, in which case the user could be prompted by the PC software to continue viewing information at the personal computer.

Ad Unit Creation

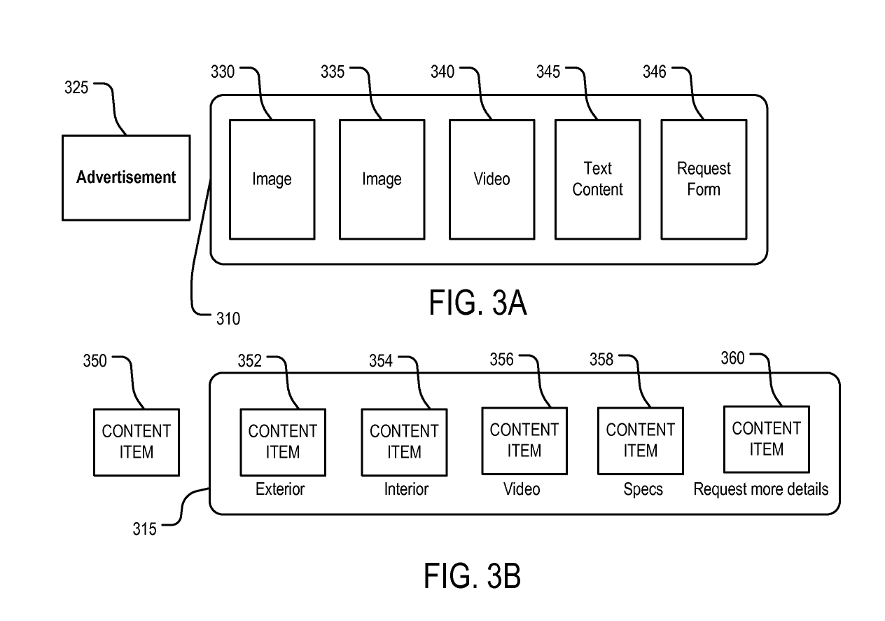

The present invention defines an ad unit to include both the advertisement and the advertisement details wherein the advertisement is linked to or used to display advertisement details as shown in FIG. 3A. The advertisement 325 may comprise traditional advertising content such as a picture banner or text advertising, or may comprise video or full screen content. The advertisement details 310 (e.g., additional media content associated with the advertisement content) may be a landing page, micro-website, or multi page digital brochure comprising rich media types including text 345, 346, images 330 and 335, audio and video 340. The advertisement details may also be interactive, such as a game and may accept user input. Advertisement details comprising multiple media types may be combined via a mark-up language such as HTML, to be displayed or otherwise presented within a compatible Web browser or defined using other scripting languages such as Flash or other proprietary mark up languages that may rely on a customized application for rendering.

FIG. 3B demonstrates an example of an ad unit for an advertisement for a new car. The car maker may have created a microsite comprising images, videos and user input forms for desktop browsers as well as a mobile device. Banner ad 350 is displayed to a user in a mobile application and when clicked the user is presented with the microsite 315 that is locally cached. 352 shows the exterior, 354 shows the interior, 356 presents a video to the user, 358 provides the user with detailed specifications and pricing and lastly 360 allows the user to enter their email address to receive more information or click a link to go to the car's website for further details.

The ad units can be stored locally on a mobile device and be uniquely identifiable so that applications on the mobile device may request and display the advertisement. The ad unit maybe created from advertising media content for purposes of this system. Alternatively the microsite maybe ingested/scanned by well-known indexing and transcoding processes to generate the ad unit from existing website content. Tracking and reporting would be handled by the advertisement server as described. User information captured during advertisement details may also be stored. The ad units may be rendered in a mobile web browser that may access the local cache on the mobile device or a proprietary application that can render the ad units. An ad unit may comprise any suitable media type supported by the mobile device (e.g., graphical content, audio, etc.) and may differ in implementation across different mobile devices based on capabilities.

Asynchronous mobile advertising platform interaction

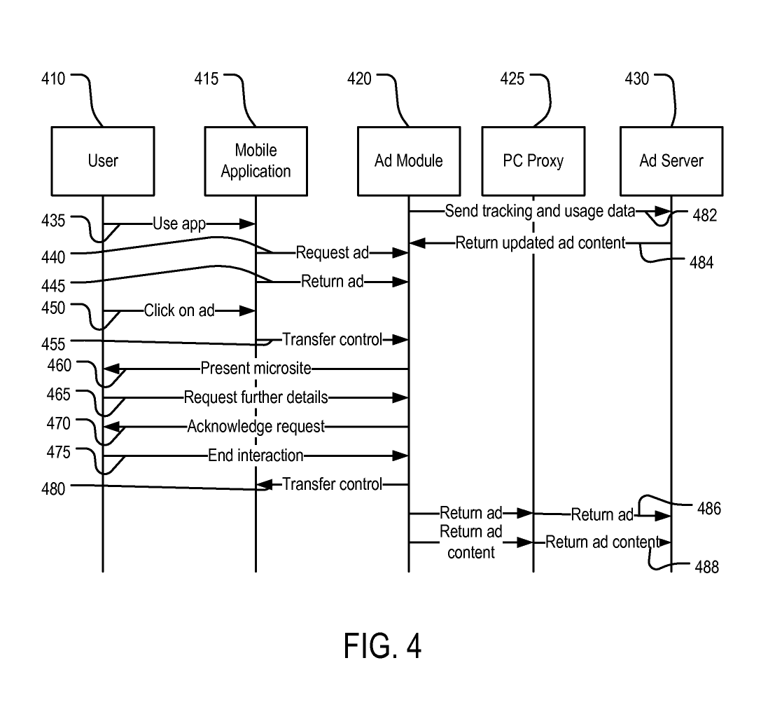

FIG. 4 demonstrates an example operation and interaction between example system components of the present disclosure. Advertisement server 430 receives user-specific information from the mobile device or the PC proxy to create a profile for the user. The user profile may include mobile device specific data such as GPS co-ordinates, preferences on applications or other configuration data. The profile maybe also be created based on the user's media collection and/or media preferences stored at a mobile device and/or at a personal computer associated with the mobile device. The Advertisement server 430 may create a collection of advertising content items 225 based on the user profile as described above and stores the collection 225 on the mobile device 210.

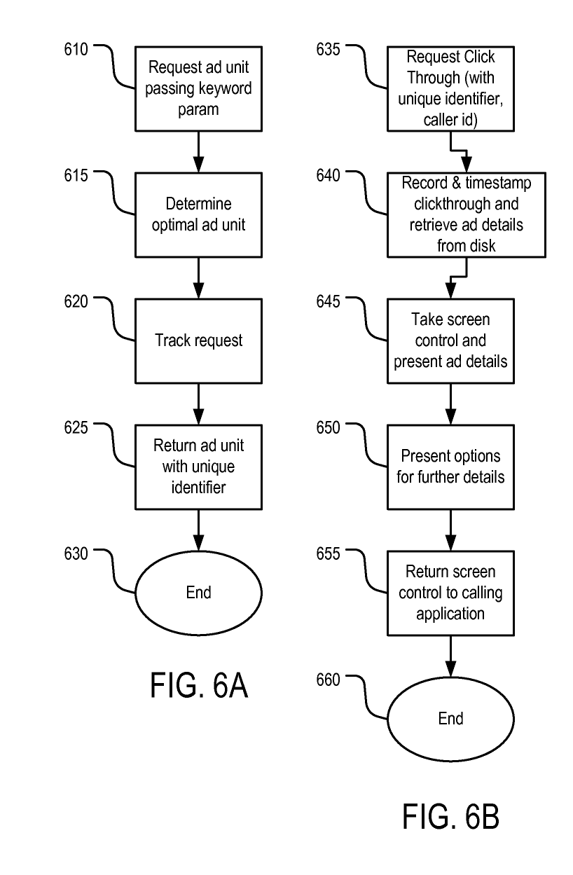

A user may begin using or otherwise interact with a mobile application 435 on a mobile device. Each application may request advertisements from the local advertisement module 420. The advertisement module receives a request and performs analytics (further illustrated in FIG. 6) using its database to select a suitable advertisement to return. The advertisement module returns the advertising component (i.e., the advertisement content item) of the Ad Unit to the mobile application for presentation 445.

From time to time a user may click or otherwise select 450 on or otherwise invoke the advertisement which transfers control to the advertisement module 455. The advertisement module retrieves advertising information for the advertisement and presents the media content associated with the advertisement (e.g., microsite) to the user 460 simulating a “virtual clickthrough”. The user may interact with the microsite and optionally request further details 465. The advertisement module processes the request 470, may end interaction 475, and may transfer control back to the mobile application 480.

The advertisement module on the mobile device may track a number of advertisement impressions, click-through rates, and other relevant metrics for advertisement content items, and may store such information in local memory. The advertisement module may then transmit such data over a wired or wireless data connection to the advertisement server 482 as they may become available. In at least one implementation, tracking and reporting metrics may be transmitted in real-time or near real-time over the carrier data network to central servers for the mobile devices equipped with wireless data plans and are in coverage. For mobile devices without data plan capability, advertisers may select the inventory but acknowledge that tracking data may be delayed until communication can be established with the advertisement server or with a personal computer (e.g., via a local area network).

In some cases, certain interactive ad units may capture data from a user (email addresses, other personal information) responsive to user input. Such data may be stored with other advertisement metrics previously described, and may be transferred to the advertisement server along with other tracking and reporting data.

The Advertisement server may be responsible for aggregating and disseminating data received from multiple devices and updating such data for advertisers. These metrics in combination with the user's demographic and information about the application or content on the device may be factored into optimizing the advertising cached on the mobile device and selection of advertising to be presented via the mobile device. The advertisement server may use such analytics to optimize ad units transferred to the mobile device.

In certain instances where a wireless connection is not available, degraded, or inefficient for transferring large amounts of data, tracking data may be received by the PC proxy where it may be sent or forwarded to the advertisement server. Similarly, new ad units may be retrieved by the PC proxy from the advertisement server and loaded onto the device over a wired connection (e.g., of a LAN).

Advertisement Server Operation

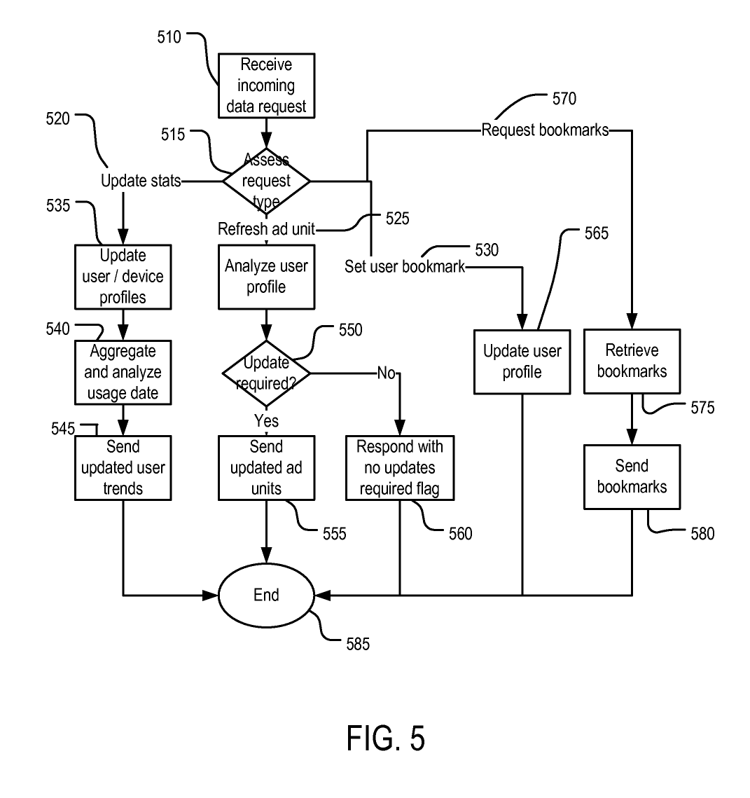

FIG. 5 demonstrates an example operation of the advertisement server. The advertisement server may receive a number of requests 510 from advertisement modules operating on a number of mobile devices or from PCs acting as a proxy for a mobile device. Statistics may be sent to the advertisement server over a wireless data connection, Internet, SMS messages, or using other suitable data transfer protocols.

If the request type is an update for statistics 520, the advertisement server reference the user profile and write the updated statistics to a local database associated with the user records. The statistics may be used to uniquely identify a mobile device or user, and provide tracking or usage data regarding user behavior or advertising effectiveness. The data may then be aggregated or analyzed from the database using a variety of tools 540. Further trend analysis may be conducted to optimize delivery of new ad units based on performance of previous ad units delivered.

Another request type may be to refresh ad units on the mobile device 525. The request may be made initiated by a user of the mobile device or may be performed according to a predefined schedule, or in response to specified events such as when a user initiates communication between a mobile device and a PC associated with the mobile device via a LAN. The advertisement server may maintain the state of the current ad units on the mobile device or may send such information to the advertisement server as part of the request. The advertisement server may analyze the user profile and ad effectiveness metrics to determine the optimal subset of ad units to transfer to the mobile device. This process may introduce new ad units that may be available for presentation at the mobile device. The advertisement server may also take into consideration device synchronization frequency and usage of the mobile device by the user to determine the number of ad units to send to the mobile device as well as the type of connection (e.g. is the mobile device wirelessly downloading the ad units or is the PC downloading the ad units over a high-speed Internet connection on behalf of the mobile device and then sideloading the ad units to the mobile device) to determine the number of Ad Units to refresh. The advertisement server may determine if the Ad Units require to be updated and if no updates are performed, may respond signaling no updates 560. If on the other hand an update is to be performed the advertisement server may send a response that contains the updated Ad Units 555. The response of the advertisement server may contain a file or other suitable collection of information that specifies the new ad units, ad units already present at the mobile device to be maintained at the mobile device and Ad Units that are to be deleted or otherwise disabled at the mobile device. The response may be sent in the form of an XML file or some other format suitable to the mobile device. The advertisement server may be enhanced to expose APIs that allow other advertisement servers or desktop software to target advertising based on user data.

Another example of a request received by the advertisement server may be a request to set a user bookmark 530 from the mobile device for future retrieval on a PC associated with the mobile device. The bookmark may be set when a user requests a website or URL that is not able to be displayed on a mobile device. The advertisement server processes the request and updates the user profile 565 and sets the bookmark. A future request 570 may be made to the advertisement server to retrieve the bookmark from the PC software or a more capable portable computing device able to render the website or URL. The request may be generated by software or initiated by the user. The advertisement server retrieves bookmarks for the user 575 and sends them to the requesting computing device 580.

Advertisement Module Operation

FIG. 6A shows the advertisement module processing a request for an advertisement content item 610 from an application on a mobile device. The advertisement module may determine the best match or most suitable match 615 by optimizing a variety of variables including advertiser specified cost per ad unit, number of ad units authorized, contextual data about the content of the application, personal information about a user as well as past performance of advertising effectiveness and user behavior. Personal information may include information discovered by accessing personal data (phonebook, contacts, calendar) as well as data such as current geographic (e.g., GPS) location and time. One advantage of the disclosed implementations is that highly personal data such as GPS location does not have to be transmitted to online servers continuously, and such data can be used by the local advertisement module for ad selection on the mobile device itself. The advertisement module selects the optimal ad unit and tracks the request from the calling application 620 as well as the advertisement served. The advertisement module returns an advertisement to the calling mobile application 625 as well as a unique identifier or domain unique identifier that the application can use to invoke the advertisement module with further details. The advertisement may be returned directly or a pointer to the advertisement may be returned such as the location of a picture on the disk and optionally a unique identifier that the application may use when the user clicks on an advertisement to invoke the display of advertisement details. If an ad unit is missing from the local cache, the advertisement module may attempt to re-download the ad unit over a data connection or select another ad unit. If no ad units are present, the advertisement module may return a default advertising message or an error message to the calling application.

FIG. 6B shows the advertisement module processing a virtual clickthrough. In traditional Internet advertising a user may click on an advertising which results in the user typically being directed to the advertiser's website. Advertisers often create landing pages for different advertisements so that a user may quickly be connected to details of the particular advertisement that was selected. These metrics may be tracked and measured, and are generally referred to as “click-throughs”. On mobile devices, a user may not be able to click-through on an advertisement as they may not presently have a data connection. Further users that do click-through over an available data connection may find the experience slow over a mobile data connection and may choose to cancel the action. However, in the disclosed implementations, because the advertisement details, in this case a micro-site or landing page of the advertiser, is cached locally on the mobile device, a user may click-through even without the presence of a data connection. Further the user may be connected with the advertising information almost instantly, avoiding wait time and reducing the likelihood of the user cancelling the action. In doing so, a user is able to “virtually click-through” an advertisement to a locally cached landing page or micro-site that exists on the device itself as described below.

When a user is interested in an advertisement displayed by a mobile application they may clickthrough or otherwise invoke the advertisement. The advertisement module receives a clickthrough request 635 from the mobile application, along with the identifier that was returned with the original advertisement 625 (in the absence of the identifier, the advertisement module may be able to determine the ad details to render based on the calling application and tracking the most recent advertisement that was returned for that application).

The advertisement module may record and timestamp the clickthough event and the application that generated the click through among other suitable information 640, and retrieves the ad details from the local storage of the mobile device. The advertisement module may present the ad details to the user by assuming screen control from the calling application. In this way the application may avoid the complexity of having to deal with advertising data. The advertisement details may optionally be presented to the user within the application the user is currently using (e.g., if the application is able to render the advertisement details) or the application may simply invoke the advertisement module to render the advertisement details allowing the user to interact with the advertising details. In some implementations, the advertisement module may directly connect the user with the advertiser's website instead of serving locally cached advertising details (e.g., if a quality of the data connection exceeds a threshold quality).

The advertisement module may then present further options for the user 650 to receive further details from the advertiser ranging from connecting the user to the advertiser's website or phone number, having email sent to the user by email or SMS or alternatively connecting the user with the advertiser the next time the user interacts with a PC associated with the mobile device (e.g., place-shifting advertising by setting bookmarks further as described below). When the user has finished interacting with the advertisement details, the advertisement module may transfer control back to the caller application 655 so the user may resume where the user left off before interacting with the advertisement. From time to time the advertisement module may send back tracking and usage data to the advertisement server.

PC Proxy Operation

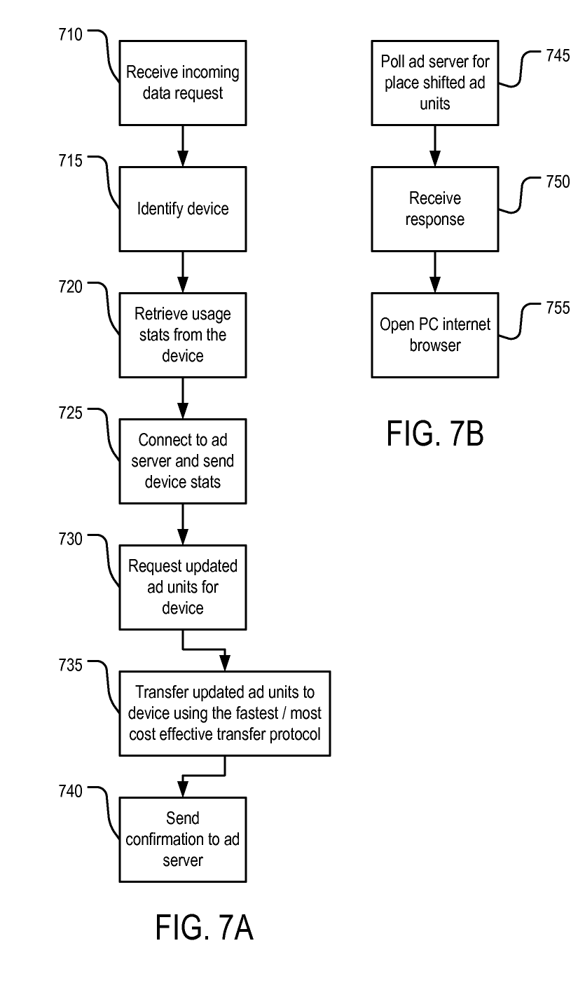

FIG. 7A shows an example of the PC Proxy acting as a proxy for a mobile device to send device statistics and update ad units on the mobile device. This operation may be implemented, for example, if the mobile device is not able to establish wireless data connections directly with the advertisement server or is unable to transfer large amounts of data over a wireless network.

The PC proxy may receive an incoming request from a mobile device 710. The connection may be made over WiFi, Bluetooth, USB cable, or other suitable local area network protocol. The PC proxy identifies the connected mobile device 715, retrieves usage statistics from the mobile device 720, and transmits such information to the advertisement server 725. The PC proxy may request updated ad units 730 for the specific mobile device, may transfer the ad units to the device 735, and may send confirmation to the advertisement server of completion of the process 740.

In another implementation, the PC proxy may download new ad units for known devices before connection with the mobile device is established so that the ad units are available for transfer to the mobile device when the mobile device initiates communication with the PC.

FIG. 7B shows an example operation of the PC proxy for a ‘place-shifted’ clickthrough. As described in the advertisement module operation, in addition to the advertisement details provided by an advertiser (if any), the user may be presented with further options to connect with the advertiser to obtain additional information relating to the advertisement, including e.g., via a phone call, SMS, or requests to have additional information emailed to the user, etc. Further, the advertisement details may optionally connect the user to the advertiser's website if a data connection is available on the mobile device.

A click through may also be place-shifted so that when a user clicks through on a mobile device, the advertisement module tracks the click through and signals the user's PC by interfacing with PC software over a wired or wireless data connection (e.g., of a LAN). When the mobile device is within communication proximity of the associated PC (e.g., as determined by a number of methods including the establishment of a wired or wireless connection) the user may continue viewing advertising details where they left off on the mobile device. In other cases where the user is not next to their PC, the user may be presented on the mobile device with the option of being reminded about the product/service the next time the mobile device establishes communication with the PC, which would then invoke the process described above.

In this way, a click through may be place-shifted so that a user may interact with an advertiser through their PC even though the click through was initiated on the user's mobile device. In some examples this approach may even be preferable to a user if, for example, the user is not able to purchase goods or perform some actions on the mobile device that may be performed on a PC, including e.g., rendering a Flash object, graphically intensive website, or completing a purchase that is supported by a PC based web browser.

As shown in FIG. 7B, the Desktop Proxy may poll the advertisement server, from time-to-time or upon request, for bookmarks set for or by the user 745. The advertisement server sends the response (e.g., as shown in 580), in one implementation, in the form of a URL that is received by the PC proxy 750 and may be opened, for example, via a web browser available on the PC 755. The PC proxy may perform this process when a mobile device establishes connection with the PC, or before establishing a connection with the PC. Alternatively, the PC proxy may prompt the user and ask if the user would like to see details at that time or at a later time. In these examples the advertisement server may track such details as a PC clickthrough, similar to traditional clickthroughs in the Internet advertising environment, for example.

Advertising Integration into Mobile Device Applications

One advantage of the disclosed implementations is that advertising data can be retrieved and displayed within mobile applications very quickly without network latency. This approach enables a higher degree of advertising integration into content unavailable with many of the present systems.

In one implementation, an online digital store front such as an electronic music store can be represented as a set of individual advertising items for digital content that can be integrated into a media player on the mobile device. The disclosed implementations enable application integration points that maximize or increase the user's exposure to advertising, thereby increasing the likelihood of the user acting on an advertisement and/or purchasing content.

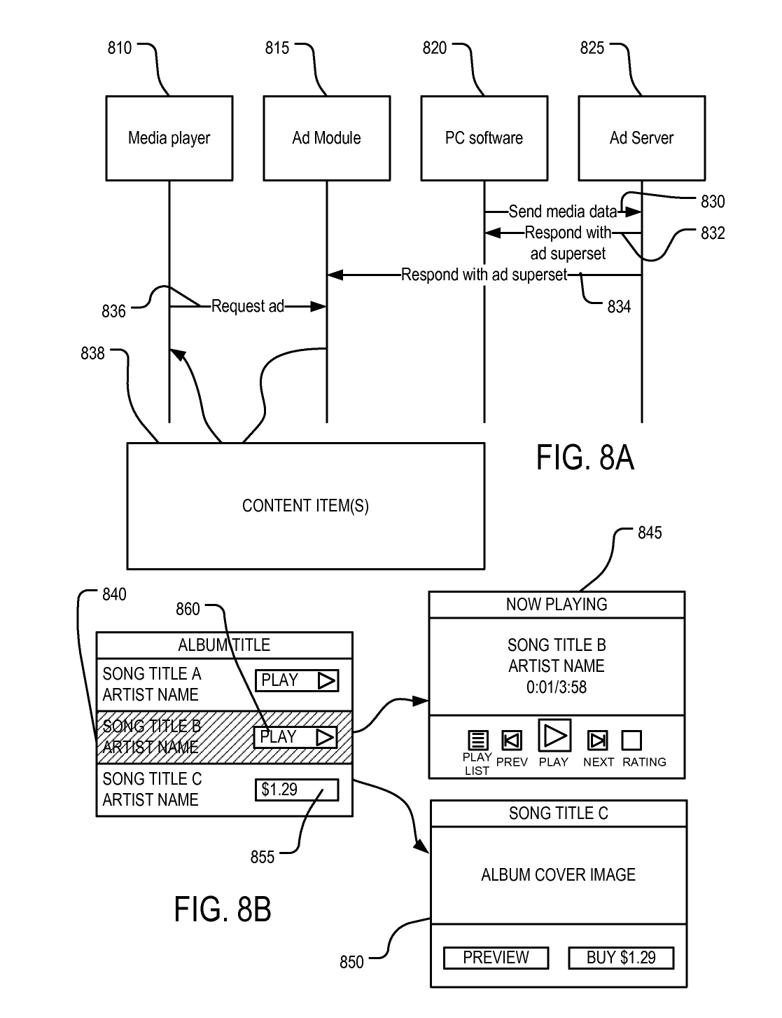

PC based software may scan the user's PC media library and may pass a list of song names and artists to advertisement server 825. Advertisement server 825 constructs a set of advertising items, in this case a discography of all music relating to the artist names received and subtracts the song names that the user presently has from the set. This set can be described as the superset of advertising items for the set of music the user has on their personal computer. The superset may be constructed, in the case of music, by looking up the music discography for each artist in a user's library to generate a complete list of tracks. Tracks in the superset that the user already has in their library may be marked as such. All or at least some of the remaining tracks not marked as part of a user's library represents a set of songs that the user is highly likely to purchase to reduce gaps in the user's music collection. The superset may contain information about the song such as the name, artist and album as well as link to purchase the song. Advertisement server 825 sends the superset of advertising items directly to mobile device 815 or to PC software 820 to be transferred to the mobile device. The data may be stored on the mobile device using a database or other well-known data structures that allow data to be queried. An example is shown in FIG. 8

When media player 810 displays a list of songs by an artist it can request a list of advertising from the advertisement module 815. The advertisement module queries advertisement content items by the artist and returns the set 836 to the media player containing the display information required as well as the link to purchase the song from the music store. Media player 810 appends/inserts the advertisements to the list 840 so that the user is prompted to purchase music that is missing from the user's collection from the music store. In this implementation, when the user clicks on a song they own, the song plays in the media player, but the user may also click on a song 855 they wish to purchase which then purchases the song from the music store. Media player 810 perform the above described operations for some or all artists and albums the user selects, because the advertising data set 838 is locally stored on the mobile device and does not require use of the wireless network.

When media player 810 is playing a song, media player 810 may implement a recommendations feature and recommend media content the user may want to purchase based on the song they are listening to by querying the advertisement module for local recommendations 838. In the implementation shown in FIG. 8, the recommended songs may be inserted among other content related to the song the user is listening to. In addition, other advertisements maybe integrated here as shown in 838.

Media player 810 can track advertisements, in this case new songs, that the user clicks on or samples, and songs that the user purchases, and may report such data back to advertisement server 825. Each time media player 810 is started or operated on the mobile device, the advertising data may be refreshed based on modifications to the user's music collection and analysis of user behavior towards previous recommendations.

Although the above example relates to music, those skilled in the art can appreciate that the above media content items can be extended to include media types such as videos, audio such as ringtones, images such as themes and wallpapers and even other applications such as games. The present invention allows rich advertising integration of new songs into a mobile application such as media player 810 due to the speed, responsiveness and relevance of ad units locally stored on the mobile device. The disclosed implementations enable a user to interact seamlessly with their own music, and advertising for new music resulting in increased song purchasing due to an improved advertising experience.

Another example of a mobile application that implements the disclosed system and methods is mapping application that uses GPS or similar location-aware mobile applications. The application may send the mobile device location to the advertisement server which constructs a set of ad units based on the mobile device location. In this case, the ad units may represent points-of-interest and local advertising within a certain proximity of the user. The superset in this example may be constructed based on user data, and may represent some or all points of interest of the surrounding city or location. As the mobile device location changes within the proximity of the city or location, the mobile application may query the advertisement module for advertising data (e.g., advertisement content items) to be displayed and recommend points-of-interest to the user in a similar manner as media player 810 for media content. The speed of presenting and integrating relevant advertising content into such a GPS application results in an improved advertising experience for the user.

The present disclosure describes how to implement a distributed advertising system where decisions on serving ad units may be made on a remote advertisement server, personal computer, or a mobile device. The present disclosure also describes how to implement localized ad units that may be used by the distributed advertising system. Together the advertising system and ad units allow for relevant advertising to be cached locally on mobile devices, thereby improving the experience and effectiveness of the advertising platform. The speed at which advertising maybe retrieved enable advertising to be integrated seamlessly into mobile applications without data network dependence or delays.

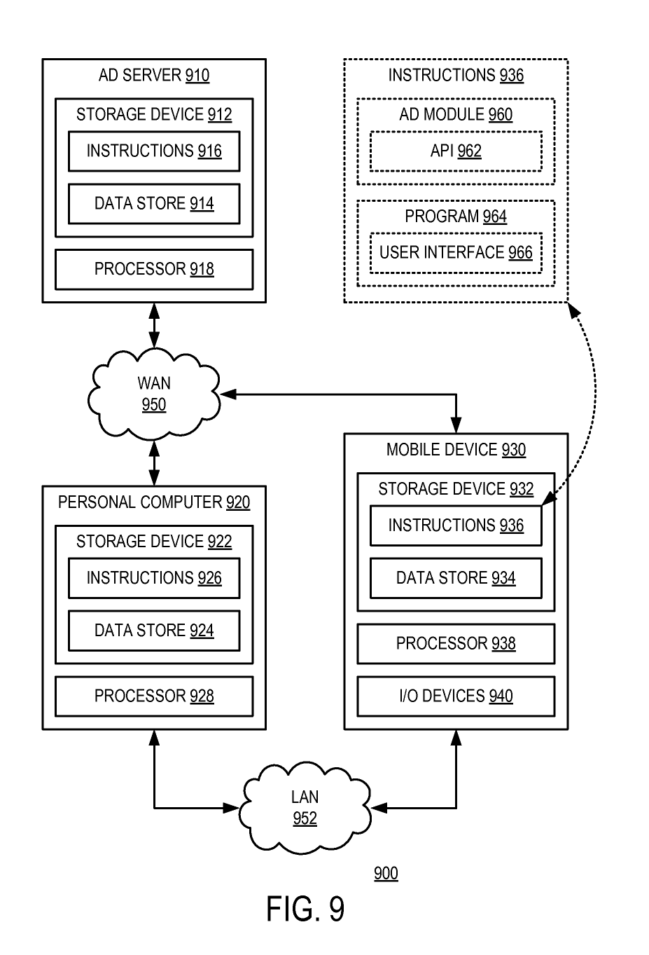

FIGS. 9, 10, and 11 depict example implementations of the preceding detailed description and associated drawings. FIG. 9 is a schematic diagram depicting an example network environment 900 according to one implementation. Network environment may include a number of computing devices, including an advertisement server 910, a personal computer 920, and a mobile device 930.

A computing device may include at least a storage device having or comprising a data store and instructions stored thereon, and one or more processors to execute instructions. For example, advertisement server 910 may include storage device 912 including data store 914 and instructions 916, and processor 918. Personal computer 920 may include storage device 922 including data store 924 and instructions 926, and processor 928, for example. Mobile device 930 may include storage device 932 including data store 934 and instructions 936, and processor 938. Mobile device 930 is further depicted as including input/output devices 940 by which media content including advertisement content may be presented and by which user input may be received. Input devices may include one or more of a button, pointing device, keyboard, touch-screen, microphone, etc. Output device may include one or more of a graphical display, audio speaker, etc.

In at least some implementations, advertisement server 910, personal computer 920, and mobile device 930 may communicate with each other via a wide area network (WAN) 950, such as the Internet, for example. In at least some implementations, mobile device 930 and personal computer 920 may communicate via a local area network (LAN) 952. LAN 952 may comprise a wireless or wired network, and may be implemented as a wired docking station link, wireless personal area network (e.g., via Bluetooth), or other suitable communication link. Mobile device 930 may communicate with advertisement server 910 via LAN 952 and personal computer 920 in some implementations. For example, personal computer 920 may serve as a proxy for mobile device 930 to communicate with advertisement server 910. In at least some implementations, personal computer 920 may be omitted from network environment 900, whereby mobile device 930 may communicate wirelessly with advertisement server 910 via WAN 950.

Computer readable storage device 932 of mobile device 930 may have or comprise instructions 936 stored thereon executable by one or more processors to perform one or more of the operations, methods, or other functionality described herein. In at least some limitations, instructions 936 may comprise one or more modules or programs. For example, instructions 936 may include an advertisement module 960 and a program 964. Program 964 may comprise a media browser program in at least some implementations, such as a media player application, a web browser, a file browser, etc.

As one example, advertisement module 960 may obtain a plurality of advertisement content items at mobile device 930 via a communication network, such as one or more of WAN 950 and/or LAN 952. As one example, advertisement module 960 may obtain one or more of the plurality of advertisement content items from personal computer 920 via LAN 952. As another example, advertisement module 960 may obtain one or more of the plurality of advertisement content items from advertisement server 910 via WAN 950.

Advertisement module 960 may store the plurality of advertisement content items at data store 934 of mobile device 930. Advertisement module 960 may receive an advertisement request via application programming interface (API) 962 from program 964 executed at mobile device 930. In at least some implementations, advertisement module 960 may form part of or may be integrated with program 964, whereby API 962 may be omitted or may be exposed to an operating system of the mobile device. The advertisement request may indicate an advertisement selection parameter that may be used to select advertisement content items for presentation to a user of the mobile device.

Advertisement module 960 may select an advertisement content item from the plurality of advertisement content items stored at storage device 932 based, at least in part, on the advertisement selection parameter. Advertisement module 960 may send an advertisement response to program 964 via the API 962 for presentation at output device 940 of mobile device 930. The advertisement response may indicate or may include the selected advertisement content item.

In at least some implementations, advertisement module 960 may update advertisement activity information stored at mobile device 930 (e.g., at data store 934) responsive to selecting the advertisement content item. Advertisement module 960 may receive (e.g., via API 962), an indication of user input directed at the advertisement content item presented via output device 940. Advertisement module 960 may update advertisement activity information stored at mobile device 930 (e.g., at data store 934) responsive to receiving the indication of the user input targeting the advertisement content item.

Mobile device 930 may send an advertisement report that includes the advertisement activity information from the mobile device to advertisement server 910 or other computing device (e.g., personal computer 920). As one example, advertisement module 960 may send the advertisement report to personal computer 920 via LAN 952. As another example, advertisement module 960 may send the advertisement report to advertisement server 910 via WAN 950.

In at least some implementations, advertisement module 960 may identify a communication quality between mobile device 930 and the communication network, and send the advertisement report that includes the advertisement activity information via the communication network if a communication quality of the communication network exceeds a threshold communication quality. For example, mobile device 930 may send the advertisement report to personal computer 920 or advertisement server 910. Advertisement module 960 may delay sending the advertisement report if the communication quality does not exceed the threshold communication quality.

In at least some implementations, advertisement module 960 may receive from program 964 via API 962, an indication of user input that was directed at the advertisement content item presented via output device 940. Advertisement module 960 may send a response to program 964 via API 962 that indicates or includes a media content item associated with the advertisement content item for presentation at output device 940 of mobile device 930.

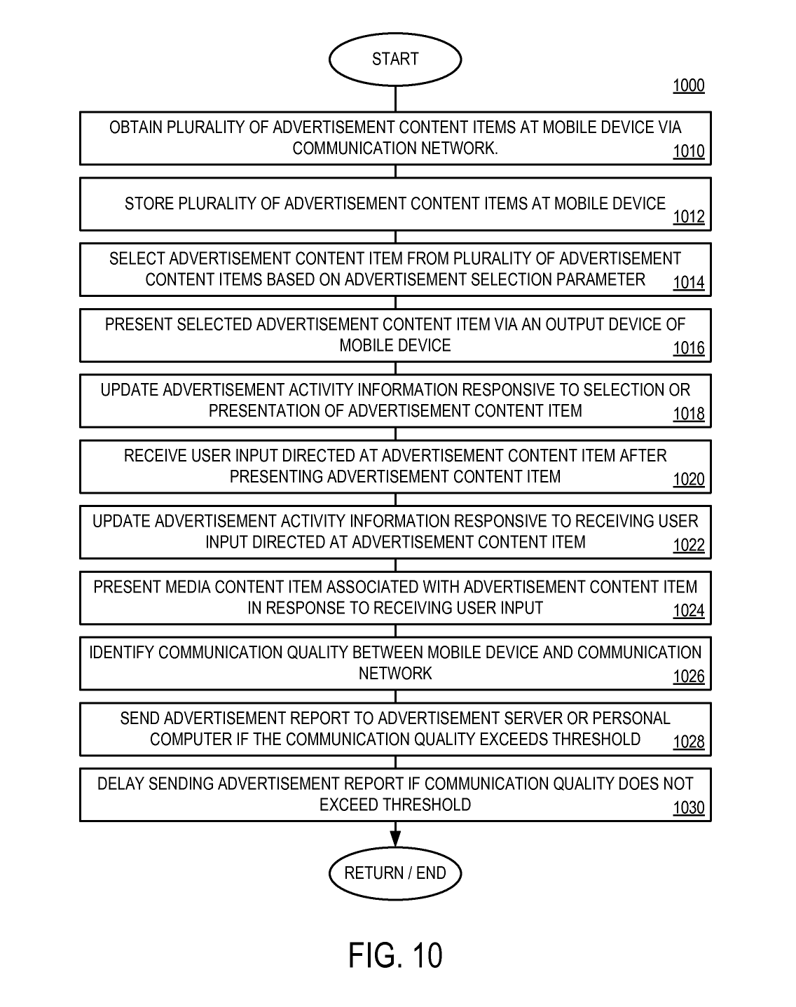

FIG. 10 is a flow diagram depicting an example method 1000 for a mobile device according to one implementation. As one example, method 1000 may be performed, at least in part, by a mobile device such as previously described mobile device 930.

Operation 1010 comprises obtaining a plurality of advertisement content items at a mobile device via a communication network. An advertisement content item may refer to an electronic file or other suitable collection of information that may be presented via a computing device as a visual advertisement and/or an audio advertisement. As previously described, advertisement content may embody a number of forms. In at least some implementations, the mobile device (e.g., via an advertisement module) may obtain the plurality of advertisement content items from another computing device (e.g., an advertisement server or a personal computer associated with the mobile device) via a communication network (e.g., a WAN and/or a LAN).

As one example, the mobile device identifies attributes of media content stored at the storage device of the mobile device or accessed by the user via the mobile device, including audio content files (e.g., music), visual content files (e.g., videos, images, text documents, html, etc.), or executable files (e.g., applications, programs, etc.). The attributes of the media content may include, for example, identifiers of the media content, such as file names or other suitable metadata (e.g., artist name, album name, etc.).

In at least some implementations, the mobile device may obtain the plurality of advertisement content items from a remote computing device (e.g., advertisement server or personal computer associated with the mobile device) by sending an advertisement request to the remote computing device via the communication network (e.g., WAN and/or LAN). As one example, the communication network is a local area network, and operation 1010 comprises obtaining the plurality of advertisement content items at the mobile device from a personal computer associated with the mobile device via the local area network. As another example, the communication network is a wide area network, and operation 1010 comprises obtaining the plurality of advertisement content items at the mobile device from an advertisement server.

The advertisement request may indicate the attributes of the media content. In at least some implementations, one or more of the plurality of advertisement content items may include advertisements for different media content than indicated by the identifiers of the media content stored at the storage device of the mobile device or accessed by the user via the mobile device. The advertisement content request may be executable by the remote computing device to select the advertisements for the different media content based, at least in part, on the identifiers of the media content stored at the storage device of the mobile device or accessed by the user via the mobile device.

The mobile device may receive the plurality of advertisement content items from the remote computing device via the communication network. One or more of the plurality of advertisement content items may be based, at least in part, on the attributes of the media content. As one example, the remote computing platform may select advertisement content items based on identifiers of the media content stored on or accessed by the mobile device. In at least some implementations, the advertisement content items may be accompanied by media content items that provide additional information relating to the advertisement content items. A user may select or otherwise direct a user input targeting the advertisement content item presented via the mobile device to be presented with the additional information provided by the media content items.

Operation 1012 comprises storing the plurality of advertisement content items at a storage device of the mobile device. Operation 1014 comprises selecting an advertisement content item from the plurality of advertisement content items stored at the storage device of the mobile device based, at least in part, on an advertisement selection parameter. In at least some implementations, the advertisement selection parameter includes one or more of a communication quality between the mobile device and the communication network, attributes of media content stored at the storage device of the mobile device or accessed by a user via the mobile device, or a geographic location of the mobile device.

As one example, an advertisement content item may be selected for presentation at the mobile device when communication with an advertisement server or other computing device for obtaining advertisements is unavailable. In this way, advertisement content items may be presented to users via a mobile device even if the mobile device is unable to communicate via a communication network. As another example, an advertisement content item may be selected for presentation at the mobile device based on a geographic location of mobile device as identified, for example, via GPS or other suitable positioning information. As yet another example, an advertisement content item may be selected based on media content items presented via the mobile device or media content items residing locally at the mobile device.

In at least some implementations, operation 1014 may further comprise receiving an advertisement request via an application programming interface (e.g., of previously advertisement module 960) from a program executed by the mobile device. The advertisement request may indicate the advertisement selection parameter(s). Operation 1014 may further comprise sending an advertisement response (e.g., from advertisement module 960) to the program via the application programming interface. The advertisement response may indicate or include the selected advertisement content item(s). Operation 1014 may further comprise selecting (e.g., at advertisement module 960) the advertisement content item in response to receiving the advertisement request from the program.

Operation 1016 comprises presenting the advertisement content item selected from the plurality of advertisement content items stored at the storage device via an output device of the mobile device. An output device of the mobile device may include, for example, one or more of a graphical display or an audio speaker. For example, presenting the advertisement content item may comprise presenting the advertisement content item via the graphical display as visual content or via the audio speaker as audio content. In at least some implementations, operation 1016 may be performed at the mobile device by or on behalf of the program that requested the advertisement content item. For example, operation 1016 may comprise presenting the advertisement content item at a user interface (e.g., graphical user interface or audio interface) of a media browser program of the mobile device. In at least some implementations, presentation of the advertisement content item may be initiated at least during a period when the mobile device is not in communication with the communication network, such as during degraded or reduced communication conditions.

Operation 1018 comprises updating advertisement activity information at the storage device of the mobile device responsive to selecting or presenting the advertisement content item. As one example, a file, database, or other suitable collection of information stored at the mobile device may be updated to reflect the identity of the advertisement content item that was selected. Additional information may be stored with the advertisement activity information, including a time stamp, among other suitable information.

Operation 1020 comprises receiving a user input directed at the advertisement content item after presenting the advertisement content item. For example, a user may operate an input device (e.g., a button, pointing device, touch-screen, microphone, etc. of the mobile device to select the advertisement content item to obtain additional information relating to the advertisement. Operation 1022 comprises updating advertisement activity information at the storage device of the mobile device responsive to receiving the user input, for example, to reflect the identity of the advertisement content item that was the target of the user input.

Operation 1024 comprises presenting a media content item via the output device of the mobile device in response to receiving the user input. The particular media content item that is presented in response to the user input may be associated with the advertisement content item, and may be identified from a collection of media content items by referencing the identity of the advertisement content item. As one example, the media content item may comprise additional information relating to the advertisement content item that was the target of the user input. For example, the media content item may comprise a sample of a full version of the media content item that may be purchased by the user via the mobile device.

Operation 1026 comprises identifying a communication quality between the mobile device and the communication network. As one example, the mobile device may identify whether the communication quality is sufficient to send data to a remote computing device. Operation 1028 comprises sending an advertisement report that includes the advertisement activity information from the mobile device to an advertisement server or to a personal computer associated with the mobile device via the communication network if the communication quality exceeds a threshold communication quality. Operation 1030 comprises delaying sending the advertisement report if the communication quality does not exceed the threshold communication quality. If sending of the advertisement report is delayed due to degraded communication quality, then the advertisement activity information may continue to be updated at the mobile device in response to selection by the mobile device, presentation by the mobile device, or user input directed at advertisement content items.

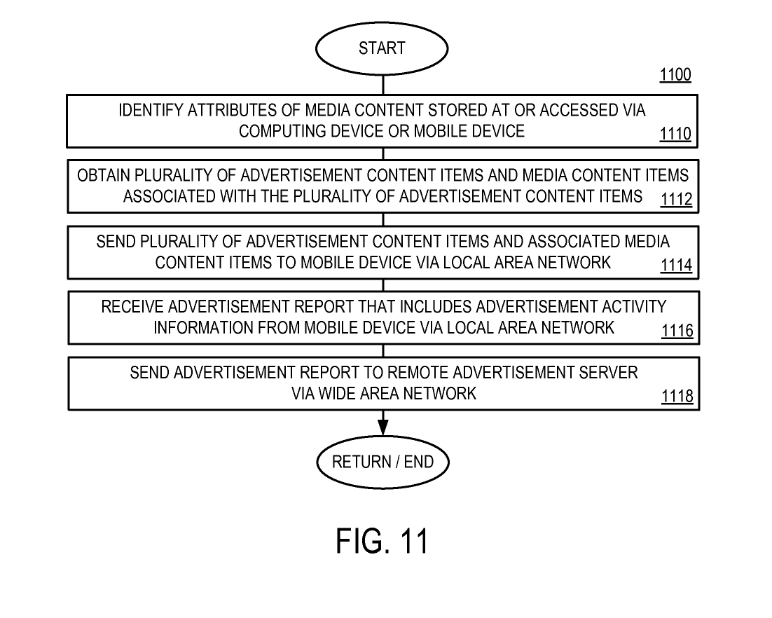

Operation 1028 may comprise sending the advertisement report to the personal computer via the local area network in some implementations. Method 1000 may further comprise obtaining the advertisement report at the personal computer via the local area network, and sending the advertisement report from the personal computer to a remote advertisement server via a wide area network as will be described in greater detail with reference to FIG. 11.

FIG. 11 is a flow diagram depicting an example method 1100 for a computing device according to one implementation. As one example, method 1100 may comprise a method for a computing device (e.g., a personal computer associated with a mobile device) for processing advertisement activity information obtained from a mobile device. The advertisement activity information may be updated and sent to the computing device by the mobile device as previously described with reference to method 1000 of FIG. 10, for example.

Operation 1110 comprises identifying attributes of media content (1) stored locally at the computing device, (2) accessed by a user via the computing device, (3) stored at the mobile device, and/or (4) accessed by a user via the mobile device. In at least some implementations, the computing device may obtain, from the mobile device via a local area network, the attributes of the media content items stored at the mobile device and/or accessed by a user via the mobile device. The mobile device may send the attributes of the media content items to the computing device via the local area network for the selection of advertisement content items in at least some implementations.

Operation 1112 comprises obtaining the plurality of advertisement content items and media content items associated with the plurality of advertisement content items. In at least some implementations, the previously described operation 1014 for selecting the advertisement content item may be applied at the personal computer to select a plurality of advertisement content items to be presented at the mobile device.

Operation 1114 comprises sending a plurality of advertisement content items to the mobile device via the local area network. As previously described, one or more of the plurality of advertisement content items may be selected based, at least in part, on the attributes of the media content. In at least some implementations, the computing device selects one or more of the plurality of advertisement content items (e.g., from a library of advertisement content items) based, at least in part, on the attributes of the media content. In at least some implementations, the computing device sends the attributes of the media content items to an advertisement server via a wide area network. The advertisement server may select one or more of the plurality of advertisement content items (e.g., from a library of advertisement content items) based, at least in part, on the attributes of the media content, and may send one or more of the plurality of advertisement content items to the computing device via the wide area network.

Operation 1116 comprises receiving an advertisement report that includes advertisement activity information from the mobile device via the local area network. The advertisement activity information may indicate presentation of one or more of the plurality of advertisement content items at the mobile device at least during a period when communication via the local area network is unavailable. The advertisement activity information may additionally or alternatively indicate user input directed at one or more of the plurality of advertisement content items presented at the mobile device at least during a period when communication via the local area network is unavailable.

Operation 1118 comprises sending the advertisement report that includes at least the advertisement activity information to a remote advertisement server via a wide area network. In at least some implementations, the computing device may aggregate advertisement activity information obtained from multiple advertisement reports received from the mobile device before sending the aggregated advertisement activity information to the advertisement server via the wide area network. As one example, the advertisement activity information may be utilized by the advertisement server for accounting or billing purposes with respect to paid advertising for the advertisement content items presented at the mobile device.

It should be understood that the embodiments or implementations described herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method for a mobile device, comprising:
obtaining a plurality of advertisement content items at a mobile device via a communication network;
storing the plurality of advertisement content items at a storage device of the mobile device;
selecting an advertisement content item from the plurality of advertisement content items stored at the storage device based, at least in part, on an advertisement selection parameter; and
presenting the advertisement content item selected from the plurality of advertisement content items stored at the storage device via an output device of the mobile device.

2. The method of claim 1, wherein the advertisement selection parameter includes a geographic location of the mobile device.

3. The method of claim 1, further comprising:
updating advertisement activity information at the storage device of the mobile device responsive to selecting or presenting the advertisement content item;
identifying a communication quality between the mobile device and the communication network;
sending an advertisement report that includes the advertisement activity information from the mobile device to an advertisement server via the communication network if the communication quality exceeds a threshold communication quality; and
delaying sending the advertisement report if the communication quality does not exceed the threshold communication quality.

4. The method of claim 3, wherein the communication network is a local area network;
wherein obtaining the plurality of advertisement content items comprises obtaining the plurality of advertisement content items at the mobile device from a personal computer associated with the mobile device via the local area network; and
wherein sending the advertisement report comprises sending the advertisement report to the personal computer via the local area network; and
wherein the method further comprises:
obtaining the advertisement report at the personal computer via the local area network; and
sending the advertisement report from the personal computer to a remote advertisement server via a wide area network.

5. The method of claim 1, further comprising:
receiving a user input after presenting the advertisement content item, the user input directed at the advertisement content item;
updating advertisement activity information at the storage device of the mobile device responsive to receiving the user input;
identifying a communication quality between the mobile device and the communication network;
sending an advertisement report that includes the advertisement activity information from the mobile device to an advertisement server via the communication network if the communication quality exceeds a threshold communication quality; and
delaying sending the advertisement report if the communication quality does not exceed the threshold communication quality.

6. The method of claim 1, further comprising:
receiving a user input after presenting the advertisement content item, the user input directed at the advertisement content item;
presenting a media content item via the output device of the mobile device in response to receiving the user input, the media content item associated with the advertisement content item.

7. The method of claim 1, wherein the output device includes one or more of a graphical display or an audio speaker; and
wherein presenting the advertisement content item comprises presenting the advertisement content item via the graphical display as visual content or via the audio speaker as audio content.

8. The method of claim 1, wherein the advertisement selection parameter includes a communication quality between the mobile device and the communication network.

9. The method of claim 1, wherein the advertisement selection parameter includes attributes of media content stored at the storage device of the mobile device or accessed by a user via the mobile device.

10. The method of claim 9, further comprising:
identifying the attributes of the media content stored at the storage device of the mobile device or accessed by the user via the mobile device;
sending an advertisement request to a remote computing device via the communication network, the advertisement request indicating the attributes of the media content; and
receiving one or more of the plurality of advertisement content items from the remote computing device via the communication network, the one or more of the plurality of advertisement content items based, at least in part, on the attributes of the media content.

11. The method of claim 10, wherein the attributes of the media content include identifiers of the media content;
wherein the one or more of the plurality of advertisement content items include advertisements for different media content than indicated by the identifiers of the media content stored at the storage device of the mobile device or accessed by the user via the mobile device; and
wherein the advertisement content request is executable by the remote computing device or other remote computing device to select the advertisements for the different media content based, at least in part, on the identifiers of the media content stored at the storage device of the mobile device or accessed by the user via the mobile device.

12. The method of claim 1, wherein presenting the advertisement content item via an output device of the mobile device comprises presenting the advertisement content item at a graphical user interface of a media browser program of the mobile device.

13. The method of claim 1, wherein presenting the advertisement content item is initiated at least during a period when the mobile device is not in communication with the communication network.

14. The method of claim 1, further comprising:
receiving an advertisement request via an application programming interface from a program executed by the mobile device, the advertisement request indicating the advertisement selection parameter; and
sending an advertisement response to the program via the application programming interface, the advertisement response indicating or including the selected advertisement content item;
wherein selecting the advertisement content item comprises selecting the advertisement content item in response to receiving the advertisement request from the program.

15. An article, comprising:
a computer readable storage device having instructions stored thereon executable by one or more processors to:
obtain a plurality of advertisement content items at a mobile device via a communication network;
store the plurality of advertisement content items at the mobile device;
receive an advertisement request via an application programming interface from a program executed at the mobile device, the advertisement request indicating an advertisement selection parameter;
select an advertisement content item from the plurality of advertisement content items stored at the storage device based, at least in part, on the advertisement selection parameter; and
send an advertisement response to the program via the application programming interface for presentation at an output device of the mobile device, the advertisement response indicating or including the selected advertisement content item.

16. The article of claim 15, the computer readable storage device further having instructions stored thereon executable by the one or more processors to:
update advertisement activity information stored at the mobile device responsive to selecting the advertisement content item;
send an advertisement report that includes the advertisement activity information from the mobile device to an advertisement server via the communication network if a communication quality of the communication network exceeds a threshold communication quality; and
delay sending the advertisement report if the communication quality does not exceed the threshold communication quality.

17. The article of claim 16,
wherein the communication network is a local area network;
wherein the instructions executable by the one or more processors to obtain the plurality of advertisement content items comprises instructions executable by the one or more processors to obtain the plurality of advertisement content items at the mobile device from a personal computer associated with the mobile device via the local area network; and
wherein the instructions executable by the one or more processors to send the advertisement report comprises instructions executable by the one or more processors to send the advertisement report to the personal computer via the local area network.

18. The article of claim 15, the computer readable storage device further having instructions stored thereon executable by the one or more processors to:
receive via the application programming interface, an indication of user input directed at the advertisement content item presented via the output device;
update advertisement activity information stored at the mobile device responsive to receiving the indication of the user input;
identify a communication quality between the mobile device and the communication network;
send an advertisement report that includes the advertisement activity information from the mobile device to another computing device via the communication network if the communication quality exceeds a threshold communication quality; and
delay sending the advertisement report if the communication quality does not exceed the threshold communication quality.

19. The article of claim 15, the computer readable storage device further having instructions stored thereon executable by the one or more processors to:
receive from the program via the application programming interface, an indication of user input directed at the advertisement content item presented via the output device; and
send a response to the program via the application programming interface, the response indicating or including a media content item associated with the advertisement content item for presentation at the output device of the mobile device.

20. A method for a computing device for processing advertisement activity information obtained from a mobile device, the method comprising:
identifying attributes of media content stored locally at a computing device, accessed by a user via the computing device, stored at a mobile device, or accessed by a user via the mobile device;
sending a plurality of advertisement content items to a mobile device via a local area network, one or more of the plurality of advertisement content items selected based, at least in part, on the attributes of the media content;
receiving an advertisement report that includes advertisement activity information from a mobile device via a local area network, the activity information indicating presentation of one or more of the plurality of advertisement content items at the mobile device at least during a period when communication via the local area network is unavailable or indicating user input directed at one or more of the plurality of advertisement content items presented at the mobile device at least during a period when communication via the local area network is unavailable; and
sending the advertisement report that includes at least the advertisement activity information to a remote advertisement server via a wide area network.
